(19) United States
(12) Patent Application Publication
(10) Pub. No.: US 2016/0139305 A1
(43) Pub. Date: May 19, 2016

(54) STRUCTURED GRANULAR COMPOSITE MATERIALS, METHODS OF FABRICATION THEREOF AND APPLICATIONS THEREOF

(71) Applicant: UNIVERSITY OF CENTRAL FLORIDA RESEARCH FOUNDATION, INC., Orlando, FL (US)

(72) Inventors: Ayman Abouraddy, Oviedo, FL (US); Aristide Dogariu, Winter Springs, FL (US); Joshua Kaufman, Oviedo, FL (US); Roxana R. Naraghi, Orlando, FL (US); Sergey Sukhov, Orlando, FL (US); Felix Tan, Orlando, FL (US)

(73) Assignee: UNIVERSITY OF CENTRAL FLORIDA RESEARCH FOUNDATION, INC., Orlando, FL (US)

(21) Appl. No.: 14/942,042

(22) Filed: Nov. 16, 2015

Related U.S. Application Data
(60) Provisional application No. 62/079,907, filed on Nov. 14, 2014.

(51) Int. Cl. G02B 5/02; D01D 5/08

(52) U.S. Cl. CPC G02B 5/0242; D01D 5/08; D10B 2401/20

(57) ABSTRACT

A structured granular optical component for use within an optical apparatus includes a primary optically active component comprising a first optical material and a secondary optically active component contained within the first optically active component and comprising a second optical material different than the first optical material. The first optical material and the second optical material are selected to influence scattering. When incorporated into a macroscopic optical apparatus the structured granular optical component provides enhanced performance.

### CROSS-REFERENCE TO RELATED APPLICATION

This application derives from, and is related to, U.S. Provisional Patent Application Ser. No. 62/079,907, filed 14 Nov. 2014 and titled “Structural Granular Composite Materials, Methods of Fabrication Thereof and Applications Thereof,” the contents of which are incorporated herein fully by reference.

### STATEMENT OF GOVERNMENT INTEREST

Research that lead to the embodiments as described herein, and the invention as claimed herein, was funded by the United States Defense Advanced Research Projects Agency (DARPA) under contract DARPA-BAA-14-56. The United States Government has rights in the invention as claimed herein.

### BACKGROUND

1. Field

The embodiments relate generally to granular composite materials. More particularly the embodiments relate to high performance structured granular composite materials, methods for fabrication thereof and applications thereof.

2. Description of the Related Art

The presence and use of optical devices and optical components continues to proliferate within various advanced technology applications, such as but not limited to optical display applications, optical inspection applications, photovoltaic energy conversion applications and biochemical optical marker applications.

Insofar as advanced technology applications continue to proliferate within a variety of optical technology areas, desirable are optical materials and optical components that may lead to optical devices and optical apparatus with enhanced performance.

### SUMMARY

Macroscopic optical apparatus are generally fabricated from optical materials that are optically adapted with respect to sub-wavelength optical dimensions. For example, in the visible spectrum where optical devices are most useful for military applications such optical adaptation often entails control over complex optical component physical architectures designed and executed at nano-scale optical dimensional limitations.

A critical optical component that may be integrated into a variety of optical systems is an optical display. Recent advances in optoelectronic device fabrication have produced a myriad of optical display architectures, not all of which are practical for field deployment within the context of a military application. Furthermore, most large-area optical displays are heavy, energy consuming and restricted in-practice to a rigid flat geometry. Indeed, such an optical display may block a user's field of view, which is an undesirable feature of most current embodiments. A transparent or opaque optical display that can provide 3D information depiction on a flat or curvilinear surface that is either opaque or transparent is thus clearly desirable. Such an optical display if possibly assembled in a field environment in a short period of time would introduce critical advantages for a range of national defense applications.

Realization of the foregoing optical attributes of optical apparatus often requires precise control over optical scattering from nano-scale features within an optical component. While lithographic strategies are often used to produce conventional display systems, the above described attributes may alternatively more readily be achieved through use of an alternative approach that allows an ordered assembly of nano-particles at macro-scales.

In that light, the embodiments intend to leverage a fabrication methodology that may be used to produce from a nano-scale optical material feedstock a composite optical element in the form of a primary polymeric nano-particle controllably structured and doped with a plurality of secondary optical scattering elements in the form of a plurality of secondary optically active components within a primary optically active component. This composite optical element can be mass-produced from the optical material feedstock using fiber spinning technology combined with thermally controllable fluid dynamic instabilities. Each element of this particular optical material feedstock is rationally designed to provide a specific optical functionality, such as high scattering efficiency with negligible absorption, well-defined polarimetric response and, potentially, wavelength selectivity. The optical material feedstock is maintained until its usage is required in a unique form-factor wherein secondary optically active components are held in isolation from each other in a fiber polymer matrix. The composite optical elements may then be assembled in macroscopic scale optical entities or apparatus by exploiting distinct deployment strategies, such as incorporation into non-woven fabric, spraying the optical material feedstock elements on a surface or painting as a coating on a substrate.

An objective of the embodiments is to provide a passive transparent optical display capable of projecting 3D image information by exploiting the engineered optical behavior of an underlying composite optical element material. One may establish the performance of such a 3D optical display across the visible spectrum and mounted on, for example, a transparent substrate.

A scalable fabrication of multi-component spun fibers is exploited to produce multi-scale composite optical element spherical particles combining amorphous and crystalline nano-scale components that enable tailored optical responses within an optical apparatus into which is included the composite optical element. The embodiments demonstrate a transparent, omni-directional, large-area optical display with a unique set of attributes that stem from underlying nano-structured composite optical elements assembled into a macroscopic optical display apparatus. This optical display is intended as passive, able to provide high-visibility/contrast on a variety of substrates, with appropriate spatial resolution, and also capable of conveying free depth perception (3D information) over the visible spectrum.

Key design elements within the context of the embodiments include:
1) A rational design of scattering elements (composite amorphous/crystalline nano-particles) to provide high scattering efficiency with negligible absorption, and well-defined polarimetric response;
2) A composite optical element that can be mass-produced by fiber-spinning technology combined with thermally controllable fluid dynamical instabilities; and
3) A composite optical element that can be assembled in macroscopic scale entities by exploiting distinct deployment strategies such as non-woven fabrics, spraying or painting on different substrates.

In comparison with alternative approaches which include, for example, conventional lithographic strategies which produce display systems that are heavy, energy-consuming, opaque, and restricted to rigid flat geometries, the embodiments provide several advantages.

In summary, the embodiments provide the following:
1) An optical display (or other optical apparatus) that can depict 2D or 3D information on a flat or curvilinear substrate, as well as an opaque or transparent surface;
2) An optical display (or other optical apparatus) that can be permanent or assembled in the field in a short period of time (e.g., by spraying);
3) An optical display (or other optical apparatus) that includes super-scattering elements that have all-dielectric composition providing a uniform spectral response;
4) An optical display (or other optical apparatus) with controlled visibility and contrast achieved by adjusting the internal structure from nano- scale to micro-scale;
5) An optical display (or other optical apparatus) with multi-view and omni-directional capabilities provided by unique scattering characteristics of composite super-scatterers; and
6) An optical display (or other optical apparatus) where depth perception is conveyed glasses-free by using polarization sensitive super-scatterers.

For reference purposes, FIG. 1 shows at top left image an optical material feedstock which at top right image is subjected to a thermal excursion to yield at middle right image a composite optical element which is shown in further detail at the bottom right image. Assembly of the composite optical element into an optical apparatus in the form of an optical display is shown at bottom left image.

Within the specification and the claims, an “optical material feedstock” is intended as at minimum a bi-component optical material prior to thermally activated extrusion cleaving into a plurality of composite optical elements.

Within the specification and the claims, a “composite optical element” is intended as a result of thermally activated extrusion cleaving of an optical material feedstock.

Within the specification and the claims, a “primary optically active component” is a larger component of a composite optical element and is generally but not exclusively in the shape of a first sphere.

Within the specification and the claims, a “secondary optically active component” is a smaller component of a composite optical element and is generally but not exclusively in the shape of a second sphere smaller than the first sphere.

Within the context of the foregoing descriptive summary the embodiments provide a composite optical element, a method for fabricating the composite optical element and an optical apparatus including the composite optical element.

A composite optical element in accordance with the embodiments includes a primary optically active component comprising a backbone material comprising an amorphous material. The composite optical element also includes a plurality of secondary optically active components contained within the primary optically active component and comprising an additive material comprising a nano/micro material, where the backbone material and the additive material are thermally and rheologically mismatched.

A method for fabricating a composite optical element in accordance with the embodiments includes extruding and thermally treating an optical material feedstock comprising an amorphous backbone material and a plurality of additive material components uniformly distributed within the amorphous backbone material to provide a plurality of composite optical elements each comprising a primary optically active component formed from the amorphous backbone material having included therein a sub-plurality of additive material components within the primary optically active component.

An optical apparatus in accordance with the embodiments includes a composite optical element comprising: (1) a primary optically active component comprising a backbone material comprising an amorphous material; and (2) a plurality of secondary optically active components contained within the primary optically active component and comprising an additive material comprising a nano/micro material, where the backbone material and the additive material are thermally and rheologically mismatched. The optical apparatus also includes a substrate upon which is located the composite optical element.

### BRIEF DESCRIPTION OF THE DRAWINGS

The objects, features and advantages of the embodiments are understood within the context of the Detailed Description of the Non-Limiting Embodiments, as set for the below. The Detailed Description of the Non-Limiting Embodiments is understood within the context of the accompanying drawings, which provide a material part of this disclosure, wherein:

FIG. 1 shows a production sequence that starts with an optical material feedstock (top left), processes same into a composite optical element (top, middle and bottom at right) for use within an optical apparatus (bottom left) in accordance with the embodiments.

FIG. 2 shows a production sequence for forming a composite optical element in accordance with the embodiments.

FIG. 3 shows microscopic images illustrating spinning characteristics (top and bottom left) and composite optical element characteristics (top and bottom) middle and right in accordance with the embodiments.

FIG. 4 shows scattering efficiency of core-shell particles with sizes as indicated. Also shown are the intensity distributions corresponding, from left to right, with core-shell particles of 325 nm, 400 nm core radii and a solid particle with the same overall size, respectively.

FIG. 5 shows multi-core structures created using the approach outlined in FIG. 2 to generate anisotropic optical polarizabilities as demonstrated by polarimetric measurements (lower right panel).

FIG. 6 shows main steps of fabricating a spur-scattering structure composite optical element. Starting from commercially available polymer granules (COP), one may combine the polymer with titania nano-particles, extrude rods that are used as cores in preforms drawn into extended fibers. Composite optical elements in the form of spherical structures are then obtained following the procedure illustrated in FIG. 2.

FIG. 7 shows the scattering patterns of potential candidates for elementary units in scattering-based displays depend on both material and internal structure. Homogeneous metallic and dielectric structures scatter preferentially in the backward and forward direction, respectively. The proposed all-dielectric particles composites on the other hand provide an intense, isotropic, and spectrally uniform distribution of scattered intensity.

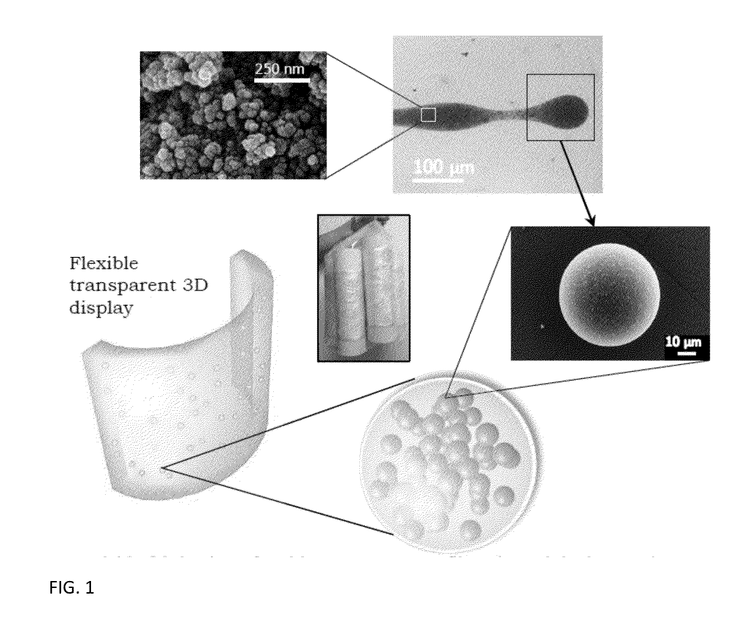

### DETAILED DESCRIPTION OF THE NON-LIMITING EMBODIMENTS

The embodiments provide an optical material feedstock that may be processed to form a plurality of composite optical elements that may be further incorporated into an optical apparatus. The composite optical elements in turn include a primary optically active component (i.e., generally a primary sphere) into which is contained a plurality of secondary optically active components (i.e., generally a plurality of secondary spheres of dimensions smaller than the primary sphere.

The embodiments also provide a method for producing the composite optical element from the optical material feedstock. The embodiments also provide the particular optical apparatus that results from the methods. Such a particular optical apparatus desirably comprises an optical display.

Within the embodiments a particular optical material feedstock includes a bulk carrier material and a plurality of secondary optically active components included within the bulk carrier material. The bulk carrier material typically includes at least one polymer material that possesses optical properties and rheological properties appropriate to provide a functional optical apparatus in accordance with the embodiments. Within the embodiments the secondary optically active components within the bulk carrier material also have specific optical properties and rheological properties to allow for a functional optical apparatus in accordance with the embodiments.

Within the embodiments the at least one polymer material which comprises the bulk polymer material may comprise, but is not necessarily limited to, a thermoplastic polymer material typically having a generally high (i.e., greater than about 90 percent) optical transparency in the visible wavelength region. Within the embodiments the secondary optically active components may comprise any of several optically active materials which may also comprise optically transparent materials. Within the embodiments the bulk carrier material and the secondary optically active components may be mutually selected to provide an optimized optical scattering which may include either a minimum optimized optical scattering or a maximum optimized optical scattering.

Typically and preferably, the optical material feedstock within the context of the embodiments includes approximately 90-95 weight percent bulk base material and about 5-10 weight percent secondary optically active component material which is uniformly mixed within the bulk base material.

A central goal of the embodiments is to demonstrate a transparent large-area optical display with a unique set of optical properties that stem from underlying composite optical element assembled into a macroscopic structure which comprises the large area optical display. Specifically, an optical display in accordance with the embodiments is intended to be passive, to provide a high visibility/contrast on a variety of substrates, and to provide an appropriate spatial resolution. The large area optical display is also capable of conveying depth perception (3D information), provided uniformly over the visible spectrum.

The above central goals with respect to the characteristics of the transparent optical display in accordance with the embodiments may be achieved by leveraging the unique material properties of high-refractive-index transparent dielectrics such as TiO₂ in conjunction with polymeric base optical materials. Starting from nano-crystalline TiO₂, one may incorporate them into a new geometry: perfect spherical polymer particles with controllable doping densities allocated within the 3D volume of each particle acting as a super-scatterer. This geometric heterogeneity provides unique opportunities for designer optical response from each composite optical element.

Furthermore, the approach used to fabricate these composite optical elements readily provides macroscopic quantities of same using standard processes delivered in a form factor that obviates traditional hurdles and impediments of agglomeration and size and structure uniformity.

The performance of an optical display in accordance with the embodiments will be engineered by leveraging the flexibility afforded by the fabrication technology in accordance with the embodiments. Specifically with respect to an optical display in accordance with the embodiments:
1. A uniform spectral response is guaranteed by the use of non-absorbing materials (all dielectrics) with non-resonant scattering and strong multiple scattering enforced by the internal structures (i.e., secondary optically active components) ranging from the nano- to micro-scales.
2. A visibility/contrast requirements is achieved by controlling the scattering efficiency (backscattering) at the nano-scale range, by adjusting the internal structure scale of these super-scatterers from nano- to at micro-, and by modifying the environment/polymer and the substrate.
3. A spatial resolution is dictated by the size of the individual super-scatterers as well as their scattering phase function determined by their internal structure over the entire range of scales involved.
4. A degree of transparency in the macroscopic assembly is set by the overall density of the super-scattering particles.
5. A depth perception (3D) is conveyed through polarization-sensitive scattering provided by enforcing anisotropic internal structure in spherical scatterers.

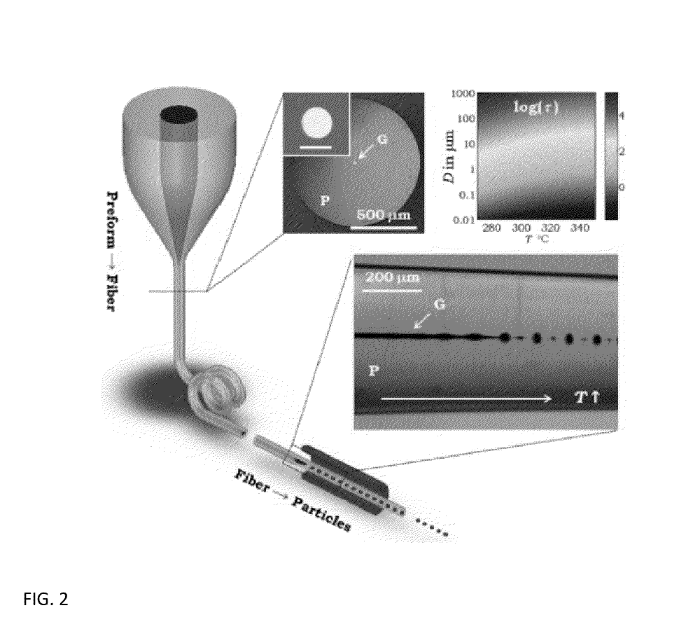

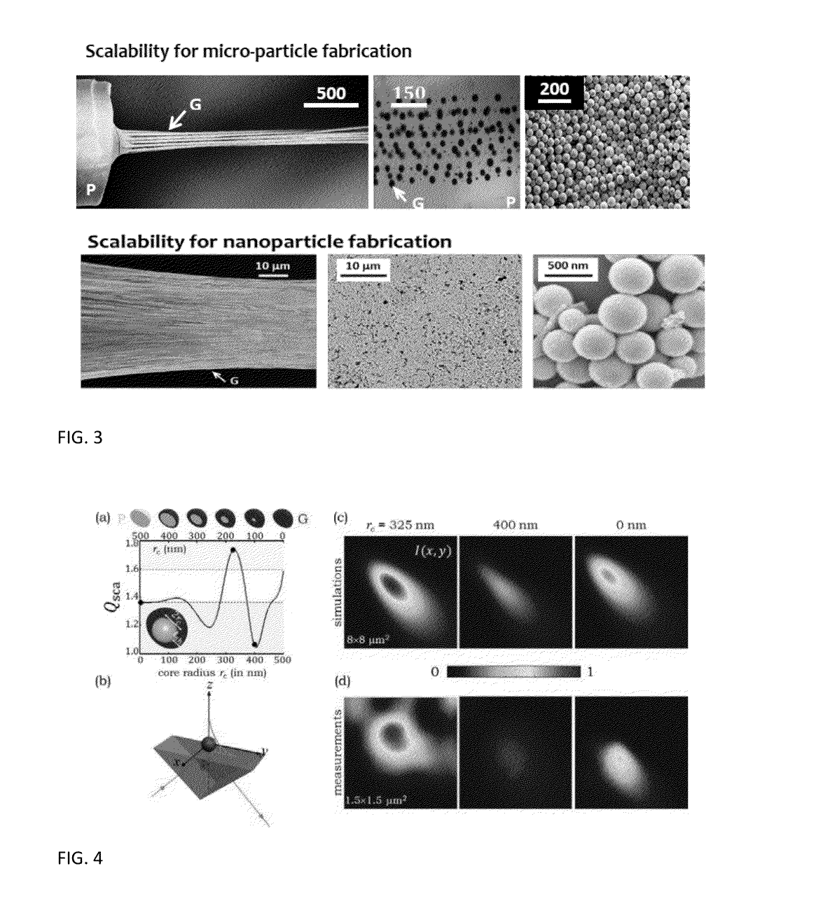

A basic approach for producing nano-particles from a multi-component fiber in accordance with the embodiments is illustrated in FIG. 2. A macroscopic ‘preform’ is thermally drawn into a microscopic fiber as described within the context of the legends, as well as illustrated by the lower right hand side drawing within FIG. 2. The break-up of the fiber into spherical particles occurs upon thermal treatment, typically at a temperature that may vary within the context of a particular optical material feedstock. FIG. 3 further illustrates that fiber break-up into spherical particles may be realized for both micro-sized particles and nano-sized particles.

The level of precise structural control over the internal particle structure shown above has profound implications for modifying the fundamental process of optical scattering. This may be confirmed through near-field optical measurements on single composite optical particles. Within the context of the embodiments, modulating the internal particle structure may increase the scattering efficiency above, or decrease it below, that of all the constitutive materials. An example is shown in FIG. 4 where the relative ratio of the diameters in a core-shell structure is varied without changing the outer particle diameter, and near-field scanning measuring coupled with theoretical calculations both demonstrate unambiguously control over the scattering efficiency.

The precise structural control over the internal particle structures produced by this technology also allows one to create unique polarization characteristics. As illustrated in FIG. 5, multi core assemblies can be easily created, which result in anisotropic polarizabilities of the overall assemblies as demonstrated by their polarimetric response at the lower right hand graph.

Within the context of the embodiments one may exploit capabilities on both fronts of large-scale computational photonics and highly precise optical characterization.

Although the above structured, multi-material micro- and nano-particle fabrication strategy has demonstrated clear and unique advantages compared to any other competing approach, it nevertheless suffers from two drawbacks to becoming an established methodology for providing composite optical element particle feedstock for controlling optical scattering across the variety of optical apparatus platforms in need of such a capability. Within the embodiments one may address these two drawbacks as follows.

With respect to a lack of scalability to mass-production, while fiber drawing is well-suited for drawing continuous long lengths of fibers, its very nature prevents scaling up to large volumes. Starting from a preform sets an upper limit on the volume that may be produced (basically the volume of the preform itself). Although such an approach is useful for applications that require small quantities of nano-particles (particularly biomedical applications), this is not the case for the applications that will be addressed in this effort, where large volumes—necessitating a clear path towards mass-production—are required.

To address this deficiency, the embodiments may use the scalable fiber fabrication methodology of fiber spinning, which is typically used to produce fibers for non-woven fabrics. To that end, using a single nozzle that already produces fibers with at least two-orders-of-magnitude larger rate (>1 kg/hr) than may be achieved using thermal fiber drawing of the same materials may be desirable. Furthermore, large scale equipment comprises multiple such nozzles operated in parallel may also be desirable. Within the context of the embodiments, one may use fiber drawing as an initial step for determining optimal materials combinations, geometries, and structures, before demonstrating the feasibility of achieving the same parameters in the more scalable fiber-spinning approach.

Within the context of materials that have been used to date to provide high optical refractive indices (i.e., soft glasses with low glass-transition temperatures such as chalcogenides) such materials suffer concomitantly from high optical losses. Thus, while optical scattering from these structured particles is enhanced, optical absorption reduces their utility.

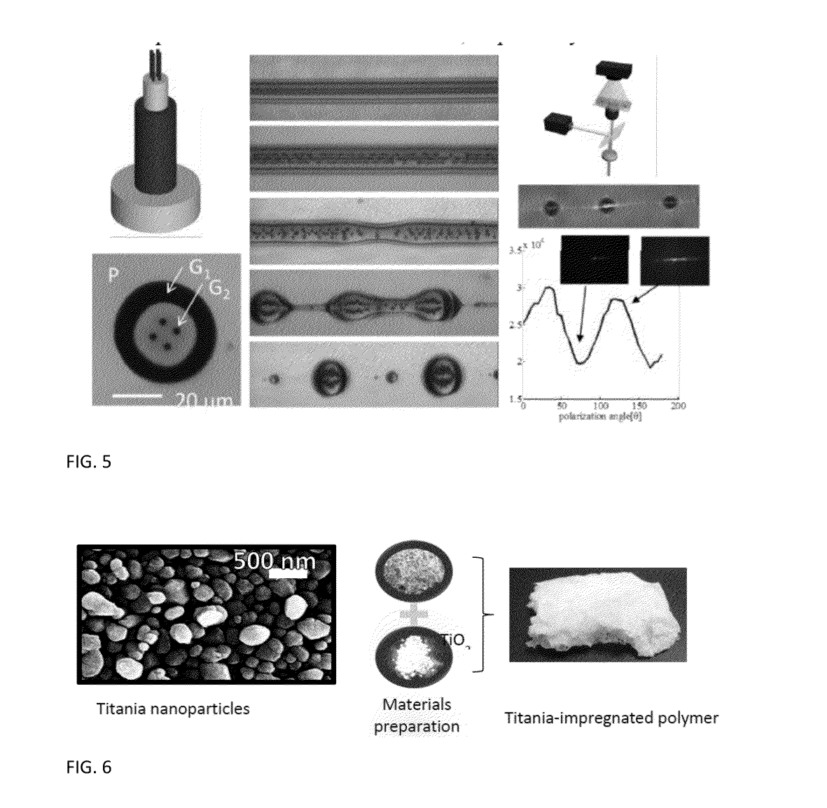

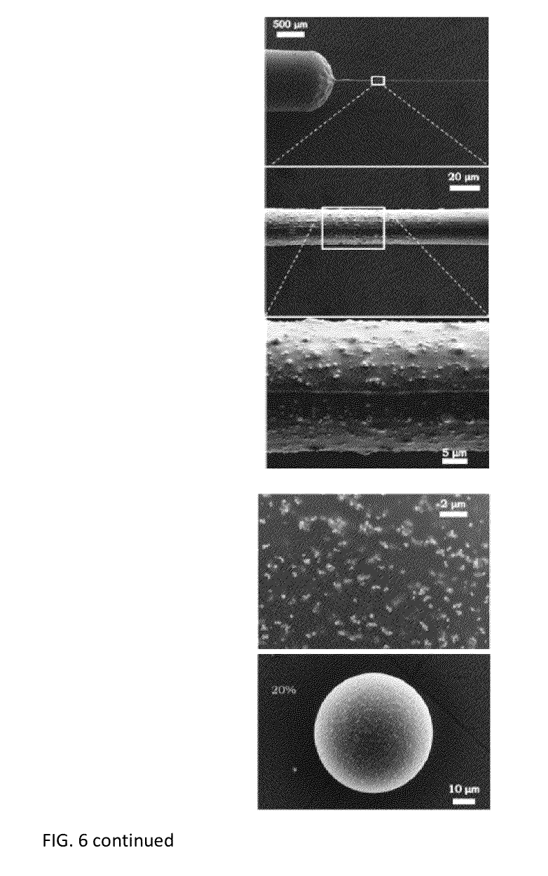

To address this particular deficiency one may use titania (TiO₂) nano-particles to provide high optical scattering in the visible while maintaining low optical absorption. Titania is a unique material that has the highest refractive index of a material transparent in the visible, is available at low prices and large volumes, and in a variety of sizes (down to a few 10's nm). One may develop a process for incorporating titania in thermoplastic polymers, thermally drawing the granular composite (polymer+titania) into fibers, and subsequent thermally driven PRI to produce particles. Moreover, one may use this granular composite in fiber-spinning machines with similar results. Preliminary experiments based fiber-spinning technology combined with thermally controllable fluid dynamical instabilities suggest that manufacturing composite structures based on titania nano-particles is feasible. The fabrication of titania-based scattering composite particles is illustrated in FIG. 6.

Multi-view 3D systems for display optical information without additional analyzing devices (glasses) rely primarily on holographic techniques. This solution however imposes significant restrictions in terms of real-time operation. Digital holography afforded by large scale diffractive optics elements can operate much faster but the overall efficiency is still seriously affected by the very nature of the display mechanism: diffraction by periodic structures.

Multi-projector approaches are another alternative. A myriad of solutions has been suggested to discretize a 3D viewing space and create a stereoscopic effect. However, so far only large scales and static applications have been demonstrated.

A solution one may pursue is fully passive and relies on the unique scattering properties afforded by non-resonant, all-dielectric particles composites. They can be incorporated in a variety of substrates to create display with various form factors.

The visibility of a scattering-based display depends on the efficiency of scattering centers and the directionality of the outgoing flow of energy. These characteristics are determined, in general, by the material properties and the length scales involved in the interaction with light. In common cases, the size of the particle determines in great degree the way in which the light is scattered or redirected. Small particles scatter light isotropically, which is highly desired for a display, but their scattering efficiency is strictly limited. Thus, it would be highly desirable to use larger particles that scatter more but, unfortunately, their efficiency is highly anisotropic. Ideally, one would require particles that are both isotropic and very efficient scatterers. In addition, one would desire the natural isotropy of spherically symmetric structures which do not require any alignment as well as lossless materials to minimize other dissipative processes. No homogeneous materials can provide all these features.

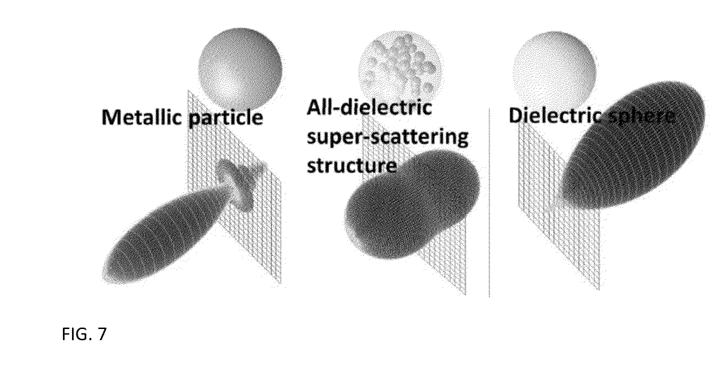

The unique approach in accordance with the embodiments relies on modifying the internal structure of large particles to permit significantly control of their scattering directivity. This task can be achieved using appropriately designed lossless composites based on nano-size TiO₂ pigments and a variety of polymeric hosts. The distinctive properties that can be achieved are illustrated in FIG. 7.

There are several optical characteristics that should be optimized for use in scattering-based displays. Aside from the choice of materials and the nano-size dimensions of the primary components, both the scattering efficiency and scattering directivity depend on the internal structure, adjustable from nano to micro scales, and the environment in which the particles are placed. Ultimately, an optical display substrate will also influence the performance. The spatial resolution is determined by the extent of embedded microstructure as well as the overall density. A uniform spectral response is anticipated due to both the non-resonant all dielectric scattering and the multiple scattering spectral homogenization generated by their internal structure.

In addition, these all-dielectric composites can also be structured such that their optical responses are strongly polarization dependent. This feature makes them capable of conveying depth perception (3D) without additional analyzing device (glasses). As illustrated in FIG. 2, the proposed manufacturing technology is capable of producing the necessary anisotropic structures. The targeted implementations of the 3D displays based on super-scattering structures are on transparent substrates such as windshields, windows, or handheld devices as well as head mounted displays on either transparent or opaque substrates. These super-scattering structures (the feedstock) can be deployed in non-woven fabrics, by spraying or painting on different substrates, which make assembled or re-assembled in the field. The mechanical and optical properties permit assembling such displays in transparent or opaque, rigid or flexible, planar or non-planar substrates.

The fabrication technology permits to conveniently add other functionalities. Different nano feedstock could be incorporated into the composite structures described here. For instance, a magnetic response can be integrated, which would allow modulating of optical response and provide unique possibilities for applications such as tagging.

Structural, mechanical, thermal and electric functionalities can be integrated with optical interface provided by super-scattering structures. One may emphasize that unique optical properties will be provided by all-dielectric materials at low optical powers where the response is linear. The functionality can be obtained without appealing to high-power or pulsed laser sources.

The following outline summarizes the embodiments. In particular, structured granular composite materials may be described as follows:
I. Specific Physical Properties of Structured Granular Composite Materials
   Mixtures or composites of amorphous backbone and crystalline/amorphous materials additives
   Backbone is bulk while the additives are granular at nano/micro scales
   Backbone and additives are thermally and rheologically mismatched (backbone has lower softening temperature)
   Backbone and additives constitute all-dielectric composites
   Backbone and additives constitute dielectric-metal composites
   Multiple form factors (geometry, shapes), including extended fibers, spherical particles, fiber mats, etc.
   Within the form factors, domains of composite (all the above) and homogeneous (with spatially invariant properties) materials can be combined in complex geometries, e.g., core-shell or multilayer structures, Janus structures, etc.
   Domain interfaces may be rough or smooth
   Multiscale structuring of the form-factor-domains from nano to micron size
   Additives are randomly but uniformly distributed in all three dimensions within the form factor domains
II. Method of Fabrication for Structured Granular Composite Materials
   Amorphous backbone is shaped using fluid dynamics, but not the additives
   Scalable (mass production based on fiber spinning possible, minimum kg per day)
   Starts from raw materials
III. Uses of Structured Granular Composite Materials

Paints and coatings for their optical properties; as reflective, transmissive or scattering elements in optical displays; whitening agents in dental applications; thermal management of optical and infrared radiation; components in other composite materials; components for thermo-mechanical control and management; optical or magnetic tags; optical microtags for authentication and security.

All references, including publications, patent applications, and patents cited herein are hereby incorporated by reference in their entireties to the same extent as if each reference was individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it was individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. A composite optical element comprising:
a primary optically active component comprising a backbone material comprising an amorphous material; and
a plurality of secondary optically active components contained within the primary optically active component and comprising an additive material comprising a nano/micro material, where the backbone material and the additive material are thermally and rheologically mismatched.

2. The composite optical element of claim 1 wherein the primary optically active component comprises a relatively large sphere shape.

3. The composite optical element of claim 2 wherein the secondary optically active component comprises a relatively small sphere in comparison with the relatively large sphere.

4. The composite optical element of claim 1 wherein the amorphous material comprises an amorphous polymer material.

5. The composite optical element of claim 1 wherein the additive material comprises an inorganic oxide material.

6. The composite optical element of claim 5 wherein the inorganic oxide material comprises titanium dioxide.

7. The composite optical element of claim 4 wherein the amorphous polymer material comprises a thermoplastic polymer material.

8. A method for fabricating a composite optical element comprising:
extruding an optical material feedstock comprising an amorphous backbone material and a plurality of additive material components uniformly distributed within the amorphous backbone material to provide a plurality of composite optical elements each comprising a primary optically active component formed from the amorphous backbone material having included therein a sub-plurality of additive material components within the primary optically active component.

9. The method of claim 8 wherein the primary optically active component comprises a relatively large sphere shape.

10. The method of claim 9 wherein the secondary optically active component comprises a relatively small sphere in comparison with the relatively large sphere.

11. The method of claim 8 wherein the amorphous material comprises an amorphous polymer material.

12. The method of claim 8 wherein the additive material comprises an inorganic oxide material.

13. The method of claim 12 wherein the inorganic oxide material comprises titanium dioxide.

14. The method of claim 11 wherein the amorphous polymer material comprises a thermoplastic polymer material.

15. An optical apparatus comprising:
a composite optical element comprising:
a primary optically active component comprising a backbone material comprising an amorphous material; and
a plurality of secondary optically active components contained within the primary optically active component and comprising an additive material comprising a nano/micro material, where the backbone material and the additive material are thermally and rheologically mismatched; and
a substrate upon which is located the composite optical element.

16. The optical apparatus of claim 15 wherein the optical apparatus comprises an optical display.

17. The optical apparatus of claim 15 wherein the amorphous material comprises an amorphous polymer material.

18. The optical apparatus of claim 15 wherein the additive material comprises a metal oxide material.

19. The optical apparatus of claim 18 wherein the metal oxide material comprises titanium oxide.

20. The optical apparatus of claim 19 wherein:
the primary optically active component comprises a relatively large sphere ; and
the plurality of secondary optically active components comprise a plurality of relatively small spheres of dimension smaller than the relatively large sphere.
